(19) United States
(12) Patent Application Publication
(10) Pub. No.: US 2011/0131229 A1
(43) Pub. Date: Jun. 2, 2011

(54) QUERY GENERATING APPARATUS,QUERY GENERATING METHOD AND DATABASE SEARCH SYSTEM

(75) Inventors: Takahide Kubota, Shizuoka (JP); Kenji Shimizu, Shizuoka (JP); Masanori Sambe, Shizuoka (JP)

(73) Assignee: TOSHIBA TEC KABUSHIKI KAISHA, Tokyo (JP)

(21) Appl. No.: 12/956,285

(22) Filed: Nov. 30, 2010

(30) Foreign Application Priority Data
Dec. 1, 2009 (JP) 2009-273799

(51) Int. Cl. G06F 17/30

(52) U.S. Cl. 707/765; 707/E17.014

(57) ABSTRACT

According to one embodiment, a query generating apparatus includes a query storing unit, a detecting unit, and a query generating unit. The query storing unit stores, in association with query identification information for identifying a database query, a query character string in which a portion of a parameter as a data retrieval condition for the database query specified by the query identification information is described as an arbitrary variable identifier. When the query identification information specifying the database query and a parameter necessary for retrieval of data are received from a client, the detecting unit detects the query character string associated with the received query identification information from the query storing unit. The query generating unit replaces the variable identifier described in the query character string detected from the query storing unit with the parameter received from the client and generates a database query.

### CROSS-REFERENCE TO RELATED APPLICATIONS

This application is based upon and claims the benefit of priority from Japanese Patent Application No. 2009-273799, filed on Dec. 1, 2009; the entire contents of which are incorporated herein by reference.

### FIELD

Embodiments described herein relate generally to a database search system in which a client configured to access a database according to execution of an application program and a query generating server configured to execute an inquiry or the like to the database in response to a request from the client are connected by a network.

### BACKGROUND

A search system for a web service includes a client configured to use the web service and a server configured to search for the web service. The client includes a query-character-string generating unit and a connection-destination-information analyzing unit. The server includes a query executing unit, a universal description, discovery, and integration (UDDI) registry search unit, and a connection-destination-information generating unit. When the server receives a database query from the client, the server analyzes the database query and executes information extraction processing or information update processing for a database.

First, the information extraction processing for the database is explained. The query-character-string generating unit of the client generates, according to input information of an extraction request, a query character string indicating the extraction request. When the query character string is generated, the query executing unit of the server converts the query character string generated by the client into a database query, which is an inquiry sentence to the database. The query executing unit sends an inquiry to the database on the basis of the database query, performs extraction processing, and acquires an extraction result.

When the UDDI registry search unit of the server acquires a binding key included in the extraction result from the query executing unit, the UDDI registry search unit searches through a UDDI registry. The connection-destination-information generating unit of the server generates, on the basis of information acquired from the UDDI registry, connection destination information necessary for invocation of the web service. When the connection-destination-information analyzing unit of the client receives the connection destination information generated by the connection-destination-information generating unit, the connection-destination-information analyzing unit performs invocation of the web service on the basis of an access point to the web service included in this information, i.e., a uniform resource locator (URL).

The information update processing for the database is explained. The query-character-string generating unit of the client generates a query character string indicating an update request in response to an update processing request of a user. When the query character string is generated, the query executing unit of the server converts the query character string generated by the client into a database query and performs update processing for information in the database.

The information extraction processing and the information update processing for the database usually take place in a process in which the client executes an application program. When the information extraction processing or the information update processing takes place, the client generates a query character string indicating an extraction request or an update request. In other words, the application program being executed needs to include a description for realizing a function for the client to generate a relevant query character string. Therefore, a developer of the application program has to be familiar with a grammar of the query character string.

For example, when a connection destination of the database, is changed or a condition for narrowing down data as an extraction target or an update target is changed, the query character string needs to be rewritten. When the query character string is rewritten, the application program itself has to be changed. In particular, in the case of a network system in which plural clients access a common database like a point of sales (POS) system, application programs installed in all the clients have to be corrected. Therefore, extremely large labor and time are required and maintenance cost for the clients increase.

### BRIEF DESCRIPTION OF THE DRAWINGS

FIG. 1 is an overall diagram of a database search system according to an embodiment;

FIG. 2 is a structure diagram of database query generation data stored in a query setting file in the embodiment;

FIG. 3 is a diagram of an example of the database query generation data in the embodiment;

FIG. 4 is a diagram of another example of the database query generation data in the embodiment;

FIG. 5 is a block diagram of main part configurations of a query generating server and a client in the embodiment;

FIG. 6 is a flowchart for explaining a processing procedure of the client performed when access processing for sending an inquiry from the client to a database takes place in the embodiment;

FIG. 7 is a flowchart for explaining a processing procedure of the query generating server performed when a query generating program installed in the query generating server is executed in the embodiment;

FIG. 8 is a schematic diagram of a pattern example of a retrieval condition input screen displayed on a display of the client, database inquiry data, and a database query in the embodiment;

FIG. 9 is a schematic diagram of an update example of the retrieval condition input screen displayed on the display of the client in the embodiment;

FIG. 10 is a diagram of an example of database query generation data stored in a query setting file to correspond to the retrieval condition input screen shown in FIG. 9; and

FIG. 11 is a schematic diagram of another pattern example of the retrieval condition input screen displayed on the display of the client, the database inquiry data, and the database query in the embodiment.

### DETAILED DESCRIPTION

In general, according to one embodiment, a query generating apparatus 2 includes a query storing unit 6, a detecting unit 201, and a query generating unit 202. The query storing unit 6 stores, in association with query identification information for identifying a database, query, a query character string in which a portion of a parameter as a data retrieval condition for the database query specified by the query identification information is described as an arbitrary variable identifier. When the query identification information specifying the database query and a parameter necessary for retrieval of data are received from a client 3, the detecting unit 201 detects the query character string associated with the received query identification information from the query storing unit 6. The query generating unit 202 replaces the variable identifier described in the query character string detected from the query storing unit 6 with the parameter received from the client 3 and generates a database query.

An embodiment of the present invention is explained below with reference to the accompanying drawings.

In this embodiment, the present invention is applied to a database search system configured to access a first database DB1 and a second database DB2. The first database DB1 stores member data such as member numbers, names, genders, and telephone numbers of members. The second database DB2 stores commodity data such as commodity codes, commodity names, and unit prices of commodities. The database search system performs extraction and update of the member data or the commodity data.

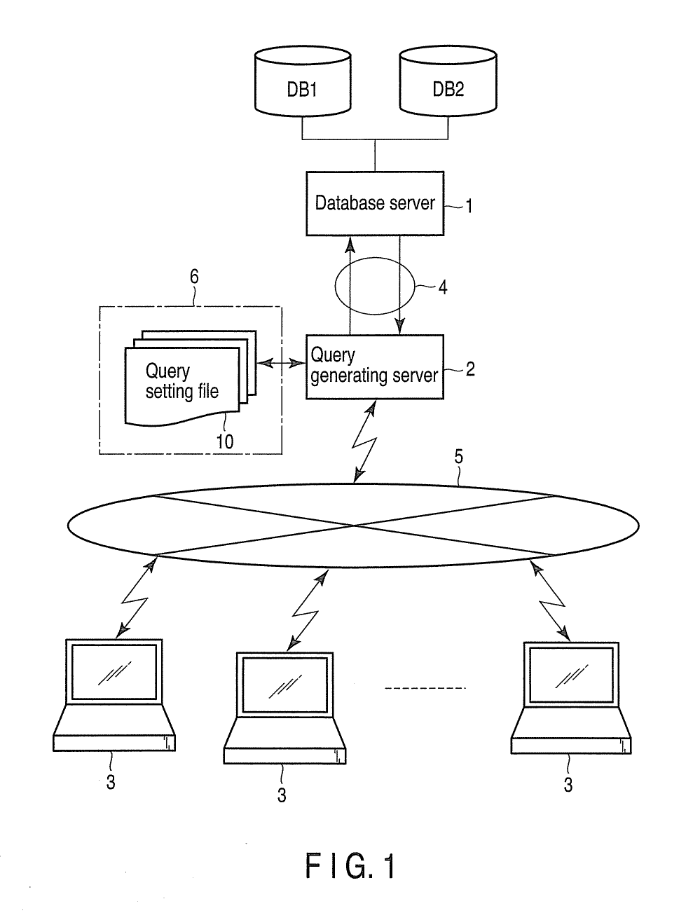

FIG. 1 is an overall diagram of the database search system according to this embodiment. The database search system includes a database server 1, a query generating server 2, and plural clients 3.

The database server 1 is connected to the query generating server 2 via a leased line 4 between the servers. The query generating server 2 is connected to the clients 3 via a network 5 such as a local area network (LAN). The database server 1 may be connected to the network 5 to perform data communication with the query generating server 2 via the network 5.

The database server 1 is a computer (a database managing server) specialized for management of the first and second databases DB1 and DB2.

The clients 3 are, for example, personal computers. The clients 3 are installed with at least application programs with which processing for accessing the databases DB1 and DB2 takes place.

The query generating server 2 is located between the clients 3 and the database server 1. The query generating server 2 is a computer (a query generating apparatus) specialized for a function of generating a database query in response to requests from the clients 3. The database query defines an inquiry to the databases DB1 and DB2.

The query generating server 2 includes a query storing unit 6. The query storing unit 6 stores plural query setting files 10. The query storing unit 6 may be provided on the inside of the query generating server 2 or may be provided on the outside of the query generating server 2.

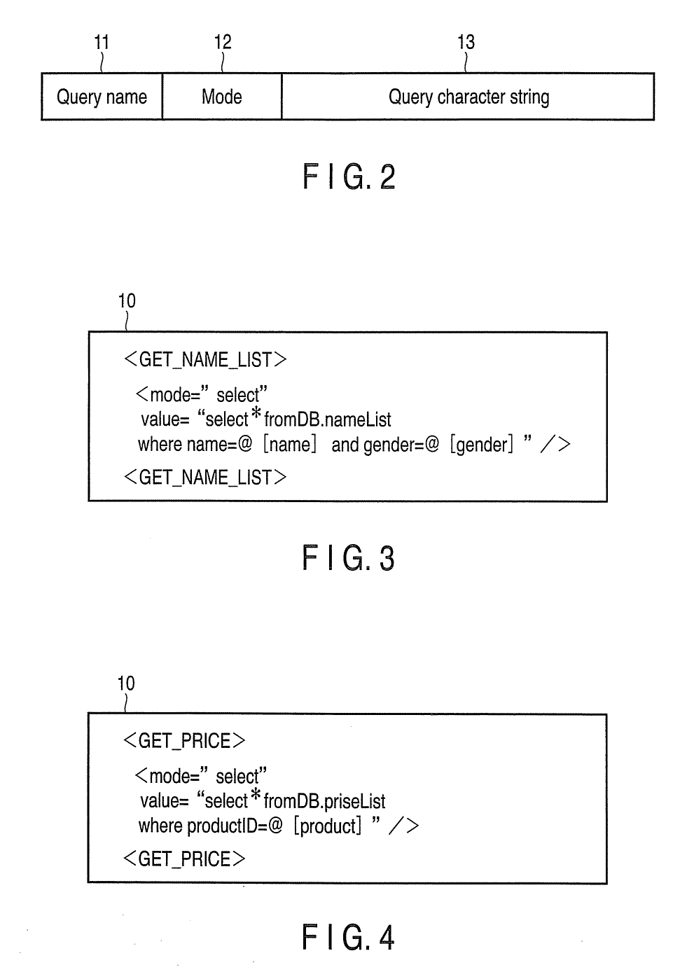

The database search system prepares the query setting files 10 for each of types of database queries used in the system. The query setting files 10 store database query generation data. The database query generation data includes, as shown in FIG. 2, a query name 11, a mode 12, and a query character string 13.

The query name 11 is query identification information for identifying a database query. The query name 11 peculiar to each of the database queries is set in the database query generation data.

The mode 12 is query type information for identifying a type of a database query. For example, when an inquiry to a database is an inquiry related to extraction of data stored in the database, data indicating an extraction mode is set in the database query generation data. For example, when an inquiry to a database is an inquiry related to update of data stored in the database, data indicating an update mode is set in the database query generation data.

The query character string 13 represents, as a character string of a predetermined language, detailed contents of an inquiry to the databases DB1 and DB2. In the query character string 13, portions of parameters as data retrieval conditions of a database query are described as arbitrary variable identifiers.

An example of the database query generation data stored in the query setting file 10 is shown in FIG. 3. In the data shown in FIG. 3, the query name 11 is <GET_NAME_LIST>, the mode 12 is “select”, and the query character string 13 is {value=“select*fromDB.nameList where name=@[name] and gender=@[gender]”}.

@[name] and @[gender] in the query character string 13 are variable identifiers. Specifically, this data is generation data for a database query for sending an inquiry to the first database DB1 in which the data of the members is stored and extracting member data of a name coinciding with a parameter set in the variable identifier @[name] and a gender coinciding with a parameter set in the variable identifier @[gender].

Another example of the database query generation data stored in the query setting file 10 is shown in FIG. 4. In this data example, the query name 11 is <GET_PRICE>, the mode 12 is “select”, and the query character string 13 is {value=“select*fromDB.priceList where productID=@[product]”}.

@[product] in the query character string 13 is a variable identifier. Specifically, this data is generation data for a database query for sending an inquiry to the second database DB2 in which the data of the commodities is stored and extracting commodity data of a commodity code coinciding with a parameter set in the variable identifier @[product].

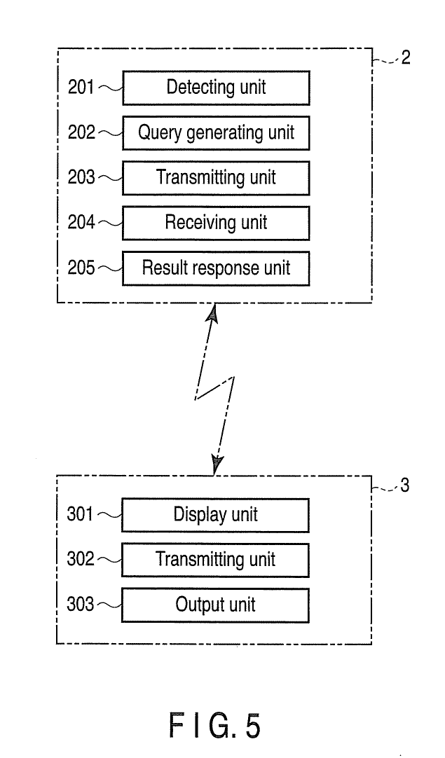

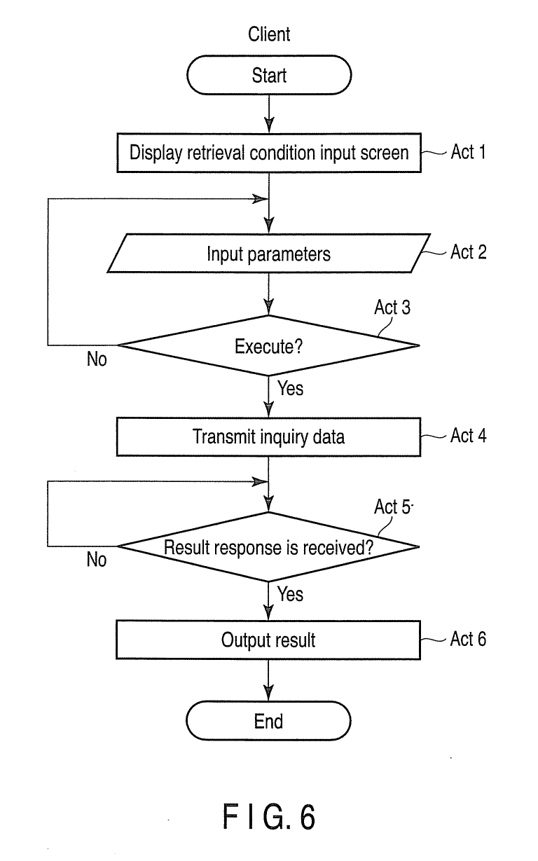

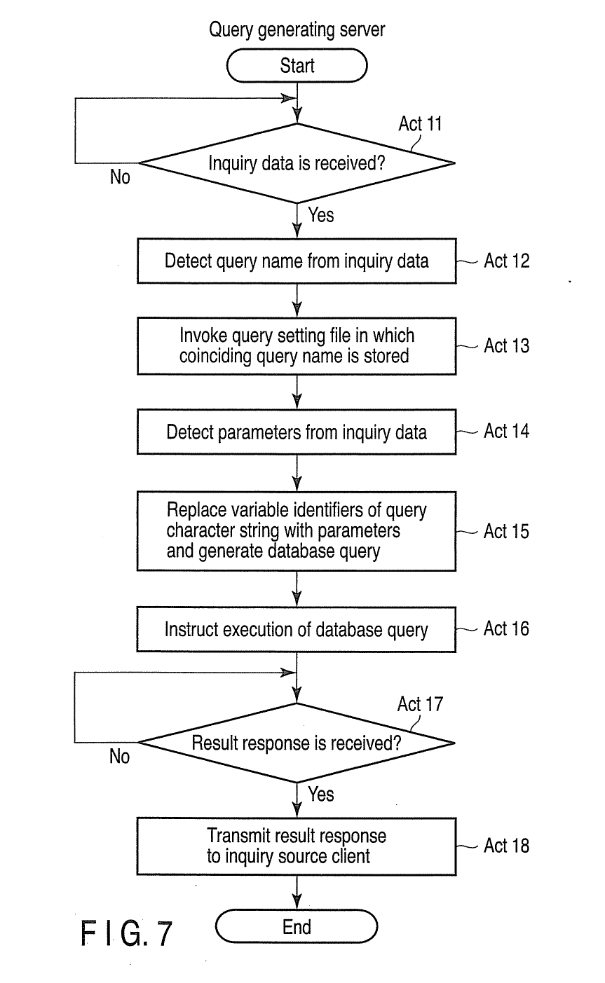

FIG. 5 is a block diagram of main part configurations of the query generating server 2 and the client 3. The query generating server 2 includes a detecting unit 201, a query generating unit 202, a transmitting unit 203, a receiving unit 204, and a result response unit 205. The client 3 includes a display unit 301, a transmitting unit 302, and an output unit 303. Functions of the units are embodied by explanation of flowcharts of FIGS. 6 and 7.

FIG. 6 is a flowchart for explaining a main part of a processing procedure of the client 3 performed when access processing for sending an inquiry to the databases DB1 and DB2 takes place according to execution of an application program.

As shown in FIG. 6, when the access processing takes place, in Act 1, the client 3 displays an input screen for retrieval conditions on a display (the display unit 301). In Act 2, parameters as the retrieval conditions are input. In Act 3, execution of processing is instructed. In Act 4, the client 3 transmits database inquiry data to the query generating server 2 via the network 5 (the transmitting unit 302).

The database inquiry data includes the parameters input as the retrieval conditions from the input screen and a query name for identifying a database query corresponding to the present access processing. Variable identifiers as replacement targets incorporated in a query character string of the database query are associated with the parameters. The query name incorporated in the database inquiry data and the variable identifiers added to the input parameters are described in the application program in advance.

After transmitting the database inquiry data, in Act 5, the client 3 stands by for a result response of the inquiry to the databases DB1 and DB2. If the client 3 receives a result response via the network 5, in Act 6, the client 3 outputs the response result (the output unit 303). As a method of outputting the response result, for example, there are display output to the display, print output to a print medium by a printer, and record output to a recording medium such as a hard disk.

FIG. 7 is a flowchart for explaining a main processing procedure executed by the query generating server 2 according to execution of a query generation program installed in the query generating server 2.

As shown in FIG. 7, in Act 11, the query generating server 2 stands by for reception of database inquiry data from any one of the clients 3. If the query generating server 2 receives database inquiry data via the network 5, in Act 12, the query generating server 2 detects a query name from the database inquiry data. In Act 13, the query generating server 2 searches through the query storing unit 6 and invokes the query setting file 10 in which database query generation data of a query name detected from the database inquiry data is stored (the detecting unit 201).

Subsequently, in Act 14, the query generating server 2 detects parameters from the database inquiry data. In Act 15, the query generating server 2 replaces variable identifiers described in the query character string 13 of the query setting file 10 invoked from the query storing unit 6 with parameters associated with the same variable identifiers and generates a database query (the query generating unit 202).

When the query generating server 2 generates the database query, in Act 16, the query generating server 2 transmits the database query to the database server 1 (the transmitting unit 203). The query generating server 2 instructs the database server 1 to execute the database query.

Thereafter, in Act 17, the query generating server 2 stands by for an execution result of the database query (the receiving unit 204). If the query generating server 2 receives a result response indicating an execution result of the database query from the database server 1, in Act 18, the query generating server 2 transmits the result response to the client 3, which is an inquiry data transmission source, via the network 5 (the result response unit 205).

The query generating server 2 ends the processing performed when the database inquiry data is received from any one of the client 3. When the query generating server 2 receives inquiry data from the plural clients 3 substantially simultaneously, the query generating server 2 can execute the processing of the procedure shown in the flowchart of FIG. 7 in parallel.

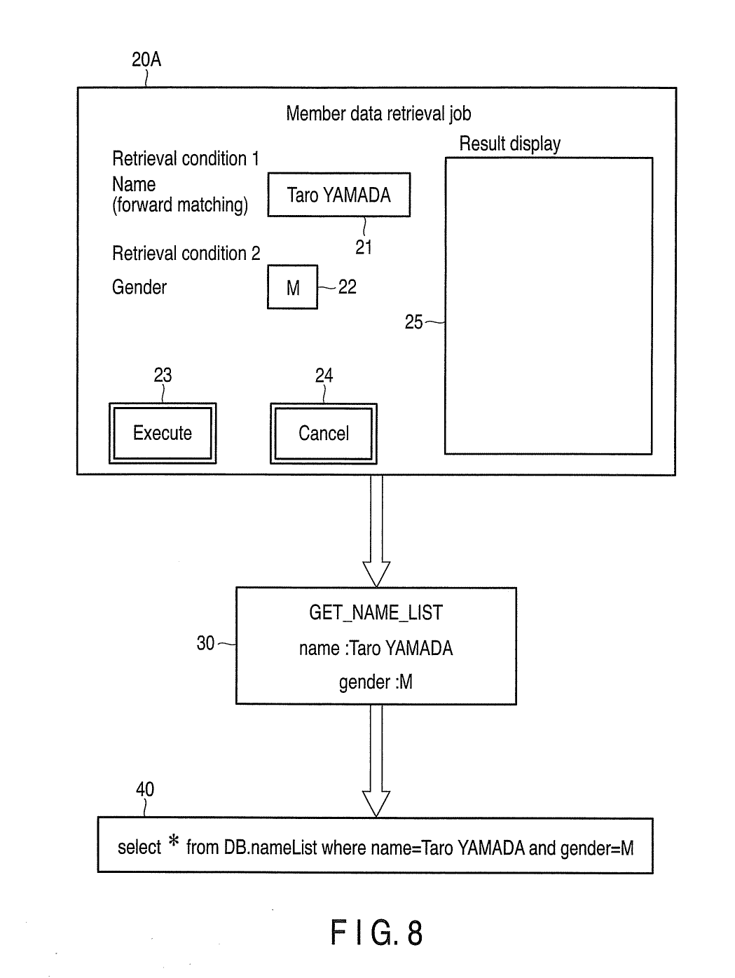

FIG. 8 is an example of a retrieval condition input screen 20A displayed on the display of the client 3. This example corresponds to the database query generation data shown in FIG. 3. Specifically, the retrieval condition input screen 20A is the screen 20A of a job for retrieving member data from the first database DB1 with a name and a gender set as retrieval conditions. The screen 20A includes an input box 21 for a name as a first retrieval condition and an input box 22 for a gender as a second retrieval condition. Further, the screen 20A includes an execution button 23 for instructing execution of retrieval, a cancellation button 24 for instructing stop of the retrieval, and an area 25 in which a retrieval result is displayed. The clients 3 set data for forming the retrieval condition input screen 20A in memories in advance.

It is assumed that, as shown in FIG. 8, an operator of the client 3 inputs “Taro YAMADA” to the input box 21, inputs “M” (M indicates male) to the input box 22, and operates (clicks) the execution button 23 on the retrieval condition input screen 20A.

Then, the client 3 transmits database inquiry data including a query name <GET_NAME_LIST>, a parameter “Taro YAMADA” associated with a variable identifier name, and a parameter “M” associated with a variable identifier gender as indicated by reference numeral 30 in FIG. 8 to the query generating server 2.

The query generating server 2 that receives the database inquiry data 30 invokes the query setting file 10 in which database query setting data with the query name 11 <GET_NAME_LIST> is stored. The query generating server 2 replaces the portion of the variable identifier @[name] in the query character string 13 {value=“select*fromDB.nameList where name=@[name] and gender=@[gender]”} of the database query setting data stored in the query setting file 10 with the parameter “Taro YAMADA” associated with the variable identifier name in the database inquiry data 30. The query generating server 2 replaces the portion of the variable identifier @[gender] with the parameter “M” associated with the variable identifier gender in the database inquiry data 30.

In this way, the query generating server 2 generates a database query {“select*fromDB.namelist where name=Taro YAMADA and gender=M”} indicated by reference numeral 40 in FIG. 8. The query generating server 2 transmits the database query 40 to the database server 1 and instructs the database server 1 to execute the database query 40.

The database server 1 extracts, according to the execution of the database query 40, member data in which the name is “Taro YAMADA” and the gender is male from the first database DB1. The database server 1 transmits the extracted member data to the query generating server 2.

When the query generating server 2 receives the member data, the query generating server 2 transmits the member data to the client 3, which is an inquiry source. The client 3 displays the received member data in the result display area 25 of the retrieval condition input screen 20A displayed on the display.

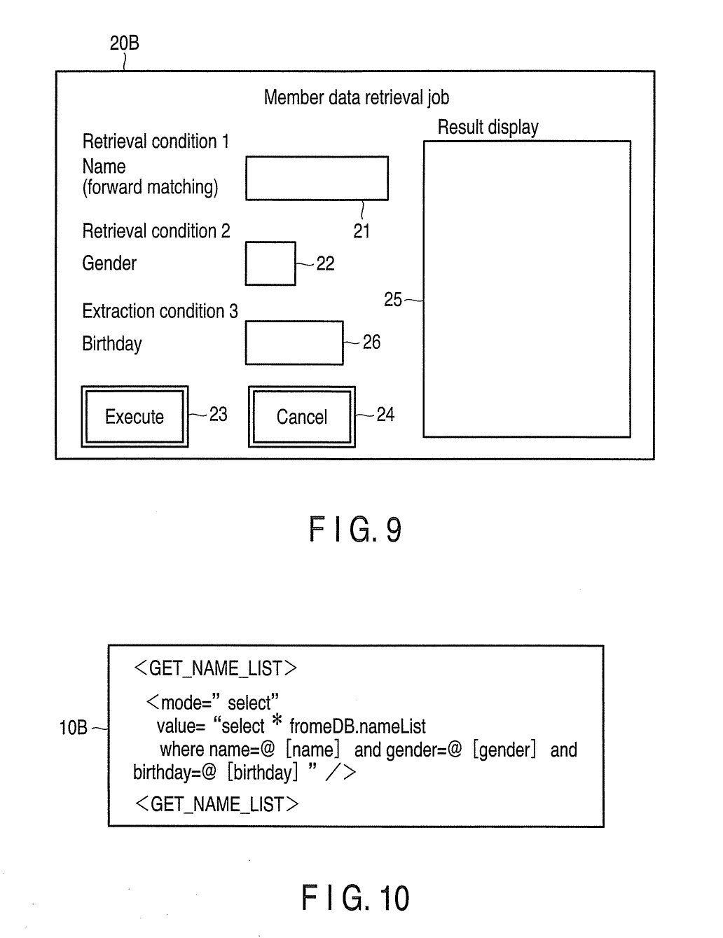

It is assumed that it is necessary to add a birthday as a retrieval condition in addition to the name and the gender in the retrieval job for member data. In this case, a retrieval condition input screen 20B displayed in the client 3 needs to be, for example, a retrieval condition input screen in which an input box 26 for the birthday is added as shown in FIG. 9. A user of the system sets data of such a retrieval condition input screen 20B in the clients 3. This point is the same in the past.

In the past, besides, in the member data retrieval job, it is necessary to change the application programs respectively installed in the clients 3 such that a query character string with the name, the gender, and the birthday set as the retrieval conditions is created.

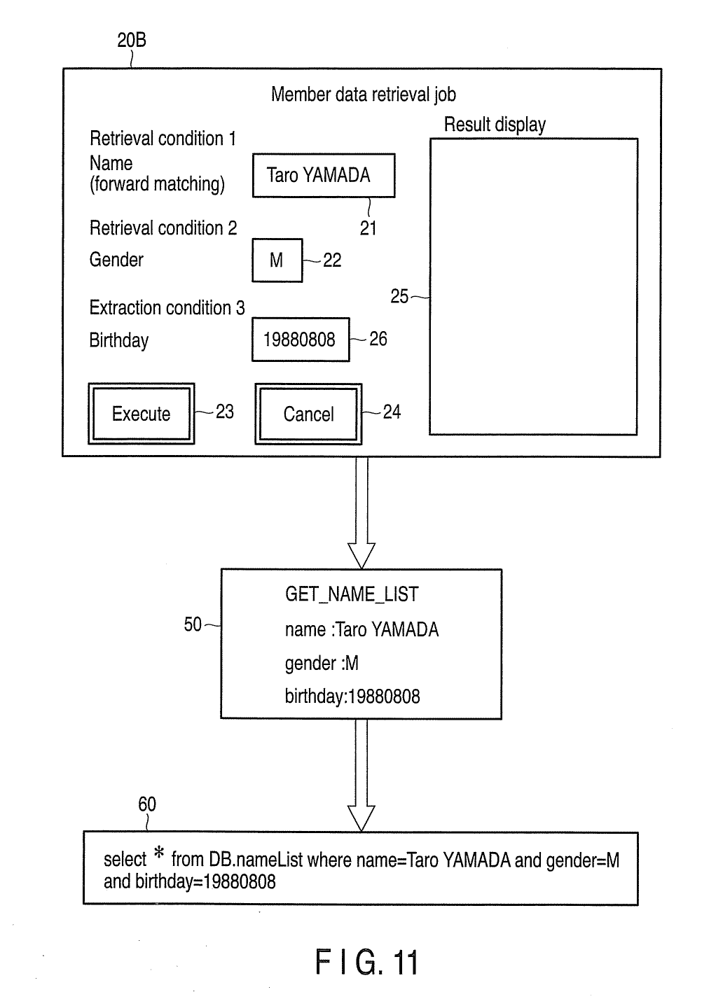

On the other hand, in this embodiment, it is unnecessary to change the application programs installed in the clients 3. The user of the system creates a query setting file 10B in which database query generation data having content shown in FIG. 10 is stored. The user overwrites and stores the query setting file 10B in the query storing unit 6 of the query generating server 2.

In the database query generation data at this point, the query name 11 is <GET_NAME_LIST>, the mode 12 is “select”, and the query character string 13 is {value=“select*fromDB.nameList where name=@[name] and gender=@[gender] and birthday=@[birthday]”}. @[name], @[gender] and @[birthday] in the query character string 13 are variable identifiers. Specifically, this data is generation data for a database query for sending an inquiry to the first database DB1 in which the data of the members is stored and extracting member data of a name coinciding with a parameter set in the variable identifier @[name], a gender coinciding with a parameter set in the variable identifier @[gender], and a birthday coinciding with a parameter set in the variable identifier @[birthday].

It is assumed that, as shown in FIG. 11, an operator of the client 3 inputs “Taro YAMADA” to the input box 21, inputs “M” (M indicates male) to the input box 22, inputs “19880808” to the input box 26, and operates (clicks) the execution button 23 on the retrieval condition input screen 20B.

Then, the client 3 transmits database inquiry data including a query name <GET_NAME_LIST>, a parameter “Taro YAMADA” associated with a variable identifier name, a parameter “M” associated with a variable identifier gender, and a parameter “19880808” associated with a variable identifier birthday as indicated by reference numeral 50 in FIG. 11 to the query generating server 2.

The query generating server 2 that receives the database inquiry data 50 invokes the query setting file 10B in which the query name 11 is <GET_NAME_LIST>. The query generating server 2 replaces the portion of the variable identifier @[name] in the query character string 13 {value=“select*fromDB.nameList where name=@[name] and gender=@[gender] and birthday=@[birthday]”1 of the query setting file 10B with the parameter “Taro YAMADA” associated with the variable identifier name in the database inquiry data 50. The query generating server 2 replaces the portion of the variable identifier @[gender] with the parameter “M” associated with the variable identifier gender in the database inquiry data 50. The query generating server 2 replaces the portion of the variable identifier @[birthday] with the parameter “19880808” associated with the variable identifier birthday in the database inquiry data 50.

In this way, the query generating server 2 generates a database query {“select*fromDB.namelist where name=Taro YAMADA and gender=M” and birthday=19880808} indicated by reference numeral 60 in FIG. 11. The query generating server 2 transmits the database query 60 to the database server 1 and instructs the database server 1 to execute the database query 60.

The database server 1 extracts, according to the execution of the database query 60, member data in which the name is “Taro YAMADA”, the gender is male, and the birthday is Aug. 8, 1988 from the first database DB1. The database server 1 transmits the extracted member data to the query generating server 2.

When the query generating server 2 receives the member data, the query generating server 2 transmits the member data to the client 3, which is an inquiry source. The client 3 displays the received member data in the result display area 25 of the retrieval condition input screen 20B displayed on the display.

In this way, even when a condition for narrowing down data as an extraction target from the database is changed, according to this embodiment, it is unnecessary to change the application program. This point is not limited to the condition for narrowing down data as an extraction target. The same applies when a condition for narrowing down data as an update target is changed. When a connection destination of the database is changed, it is also unnecessary to change the application program.

Therefore, since the query character string can be rewritten even if the application program installed in the client 3 is not corrected, there is an effect that it is possible to easily design and change the application program installed in the client 3. Such an effect is particularly conspicuous in a network system in which plural clients access a common database. It is possible to substantially reduce maintenance cost for the client 3.

In the application program, a description for realizing a function of the client 3 to generate a relevant query character string is unnecessary. Therefore, a developer of the application program does not need to be familiar with a grammar of the query character string and a burden on the developer can be reduced.

In the above explanation of this embodiment, the computer program for carrying out the invention is recorded on the inside of the query generating server 2 in advance. However, the present invention is not limited to this. The same computer program may be downloaded from a network to the query generating server 2. A recording medium having the same function stored therein may be installed in the query generating server 2. A form of the recording medium may be any form as long as the recording medium can store a computer program like a CD-ROM and can be read by a server. The function obtained by the installation or the download in this way in advance may be realized in cooperation with an operating system (OS) or the like on the inside of an apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A query generating apparatus comprising:
a query storing unit configured to store, in association with query identification information for identifying a database query, a query character string in which a portion of a parameter as a data retrieval condition for the database query specified by the query identification information is described as an arbitrary variable identifier;
a detecting unit configured to detect, when the query identification information specifying the database query and a parameter necessary for retrieval of data are received from a client, the query character string associated with the received query identification information from the query storing unit; and
a query generating unit configured to replace the variable identifier described in the query character string detected from the query storing unit with the parameter received from the client and generate a database query.

2. The apparatus of claim 1, wherein
the parameter is associated with a variable identifier as a replacement target, and
the query generating unit replaces the variable identifier described in the query character string detected, from the query storing unit with a parameter associated with the same variable identifier among parameters received from the client.

3. The apparatus of claim 1, further comprising a transmitting unit configured to transmit the database query generated by the query generating unit to a management server for a database.

4. The apparatus of claim 3, further comprising:
a receiving unit configured to receive an execution result of the database query from the management server for the database; and
a result response unit configured to transmit information indicating the execution result received by the receiving unit to the client.

5. A query generating method comprising:
providing, in a computer, a query storing unit configured to store, in association with query identification information for identifying a database query, a query character string in which a portion of a parameter as a data retrieval condition for the database query specified by the query identification information is described as an arbitrary variable identifier; and
the computer detecting, when the query identification information specifying the database query and a parameter necessary for retrieval of data are received from a client, the query character string associated with the received query identification information from the query storing unit, replacing the variable identifier described in the query character string with the parameter received from the client, and generating a database query.

6. The method of claim 5, wherein
the parameter is associated with a variable identifier as a replacement target, and
the computer replaces the variable identifier described in the query character string detected from the query storing unit with a parameter associated with the same variable identifier among parameters received from the client.

7. A database search system comprising:
a client configured to execute an application program; and
a query generating server to which the client is connected via a network, wherein
the query generating server includes:
a query storing unit configured to store, in association with query identification information for identifying a database query, a query character string in which a portion of a parameter as a data retrieval condition for the database query specified by the query identification information is described as an arbitrary variable identifier;
a detecting unit configured to detect, when the query identification information specifying the database query and a parameter necessary for retrieval of data are received from the client, the query character string associated with the received query identification information from the query storing unit; and
a query generating unit configured to replace the variable identifier described in the query character string detected from the query storing unit with the parameter received from the client and generate a database query, and
the client includes:
a display unit configured to display an input screen for the parameter every time an event of an inquiry to the database takes place according to the execution of the application program; and
a transmitting unit configured to transmit the parameter, which is input from the input screen, to the query generating server together with the query identification information for specifying the database query.

8. The system of claim 7, wherein
the transmitting unit of the client associates the variable identifier as the replacement target with the parameter input from the input screen and transmits the parameter to the query generating server, and
the query generating unit of the query generating server replaces the variable identifier described in the query character string detected from the query storing unit with a parameter associated with the same variable identifier among parameters received from the client.

9. The system of claim 7, wherein the query generating server further includes a transmitting unit configured to transmit the database query generated by the query generating unit to a management server for a database.

10. The system of claim 9, wherein
the query generating server further includes:
a receiving unit configured to receive an execution result of the database query from the management server for the database; and
a result response unit configured to transmit information indicating the execution result received by the receiving unit to the client, and
the client further includes an output unit configured to output information indicating the execution result received from the query generating server.
